(19) United States
(12) Patent Application Publication
(10) Pub. No.: US 2007/0238484 A1
(43) Pub. Date: Oct. 11, 2007

(54) Wireless peripheral with a multi-function control

(75) Inventor: Chuanli Liu, Chapel Hill, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/391,018

(22) Filed: Mar. 28, 2006

(51) Int. Cl. H04B 1/38; H04M 1/00

(52) U.S. Cl. 455/557

(57) ABSTRACT

A wireless peripheral described herein includes at least one multi-function control. Activation of the multi-function control controls different functions related to operation of a corresponding mobile device in different operating modes. In one non-limiting example, the wireless peripheral performs a call function responsive to activation of a multi-function control in a call mode, and performs a camera function responsive to activation of the same multi-function control in a camera mode.

### BACKGROUND

This invention relates generally to wireless peripherals compatible with mobile devices, and more particularly to wireless peripherals with multi-function controls.

As cellular telephones become more ubiquitous, the demand for cellular telephone accessories also increases. Exemplary accessories include desk stands, chargers, multi-media connectors, wired headsets, wireless headsets, etc. Wireless headsets represent one particularly popular accessory because they enable hands-free and cable-free communication.

Typically, a wireless headset includes various dedicated controls, such as a call answer control, volume control, etc. In some instances, a wireless headset also includes controls dedicated to auxiliary functions, such as digital music player functions. While additional dedicated controls increase the functionality of a wireless headset, size constraints may limit the availability of such dedicated controls.

### SUMMARY

An exemplary wireless peripheral, such as a wireless headset, includes at least one multi-function control that controls different functions related to the operation of a mobile device in different operating modes. In other words a single multi-function control on the wireless peripheral controls a first function in a first operating mode and controls a second function in a second operating mode.

The wireless peripheral is modal, the mobile device is modal, or both are modal. Further, either the wireless peripheral or the mobile device selects the current operating mode responsive to a mode selection input provided to the wireless peripheral and/or the mobile device.

According to one embodiment, a mobile device interfaces with a nearby modal wireless peripheral. The wireless peripheral includes one or more multi-function controls. In a first operating mode, the peripheral performs a first function responsive to activation of a multi-function control. In a second operating mode, the peripheral performs a different second function responsive to activation of the same multi-function control. According to one exemplary embodiment, the wireless peripheral performs the different functions by generating different control signals responsive to activation of a single multi-function control in different operating modes. As a non-limiting example, the peripheral generates a camera control signal responsive to activation of a multi-function control in a camera mode and generates a call control signal responsive to activation of the same multi-function control in a call mode.

According to another embodiment, a modal mobile device interfaces with a nearby wireless peripheral. The mobile device performs different functions responsive to receiving a common control signal in different operating modes. For example, the modal mobile device performs a camera function responsive to receiving a control signal in a camera mode, and performs a call function responsive to receiving the same control signal in a call mode.

Broadly, a multi-function control of the wireless peripheral controls different functions related to the operation of a mobile device in different operating modes. By allowing the same control to control different functions in different operating modes, the wireless peripheral can include one or more multi-function controls that save space and/or simplify control layouts.

### BRIEF DESCRIPTION OF THE DRAWINGS

FIG. 1 illustrates one exemplary wireless peripheral and mobile device according to the present invention.

FIG. 2 illustrates a block diagram of an exemplary wireless peripheral in communication with a mobile device.

FIG. 3 illustrates a flow chart for an exemplary process associated with the wireless peripheral.

FIG. 4 illustrates a block diagram of an exemplary mobile device in communication with a wireless peripheral.

FIG. 5 illustrates a flow chart for an exemplary process associated with the mobile device.

### DETAILED DESCRIPTION

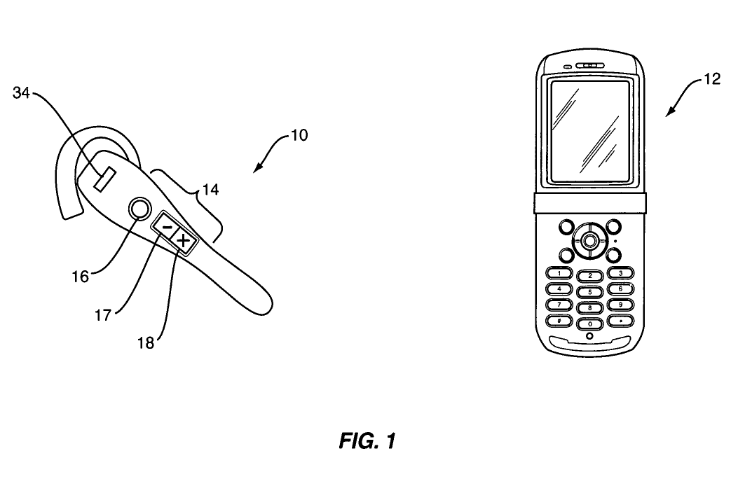

FIG. 1 illustrates an exemplary wireless peripheral 10, such as a wireless headset, and a compatible mobile device 12, such as a cellular telephone. Peripheral 10 includes one or more multi-function buttons or controls 14 that control different functions related to the operation of mobile device 12 in different operating modes. For example, multi-function controls 14 control call functions related to call operations of mobile device 12 in a call mode, and control camera functions related to a camera in mobile device 12 in a camera mode. While FIG. 1 illustrates only three multi-function controls 14, controls 16, 17, and 18, those skilled in the art will appreciate that peripheral 10 may include fewer or additional multi-function controls 14, and may include one or more single function controls (not shown).

Either wireless peripheral 10, mobile device 12, or both are modal. When wireless peripheral 10 is modal, the wireless peripheral 10 generates different control signals responsive to activation of a single multi-function control 14 to perform the different functions in the different operating modes. The different control signals may comprise a local peripheral control signal in one mode and a remote control signal for transmission to the mobile device 12 in another mode. Alternatively, the different control signals may comprise different remote control signals for transmission to mobile device 12 in different operating modes. When mobile device 12 is modal, the mobile device 12 controls different functions related to mobile device operations responsive to receiving the same control signal from the wireless peripheral 10 in different operating modes.

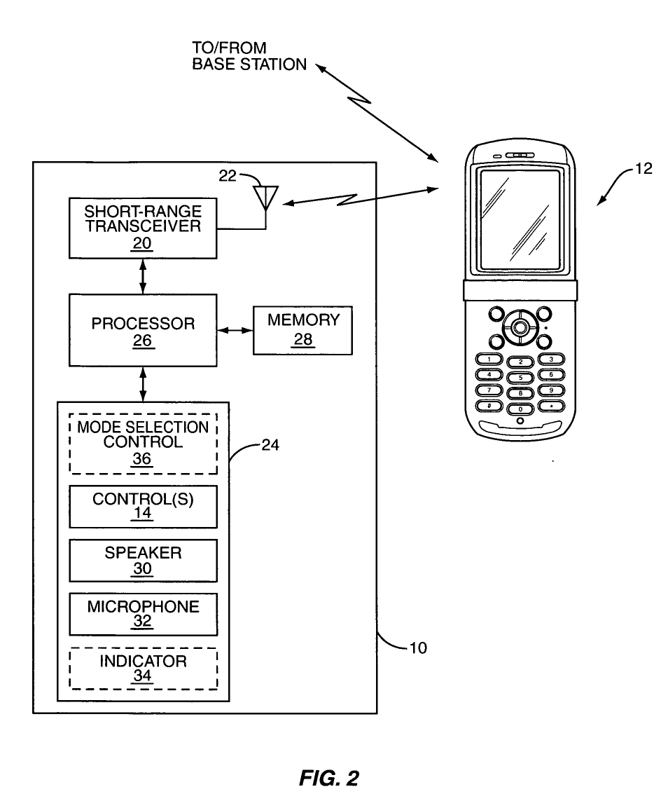

FIG. 2 illustrates a block diagram of an exemplary wireless peripheral 10. Peripheral 10 includes an interface, such as a short-range wireless transceiver 20 and antenna 22, for communicating with a nearby mobile device 12. Short-range wireless transceiver 20 communicates with nearby mobile device 12 using any known technology applicable to transmitting and receiving signals over short distances, such as Bluetooth®, infrared, RF according to IEEE 802.11a, IEEE 802.11b, IEEE 802.11g, etc.

Wireless peripheral 10 further includes a user interface 24, processor 26, and memory 28. User interface 24 enables the user to interact with peripheral 10. In addition to multi-function control(s) 14, user interface 24 includes a speaker 30 that projects audible sound and a microphone 32 that receives audible input according to any known means. User interface 24 optionally includes a display (not shown) and/or an indicator 34 to provide operation information to the user. Further, user interface 24 optionally includes a mode selection control 36, such as a toggle switch, configured to select a current operating mode. Processor 26 performs various processing tasks, including controlling the overall operation of peripheral 10, according to programs stored in memory 28. When peripheral 10 is modal, processor 26 responds differently in different modes to the actuation of the same multi-function control 14.

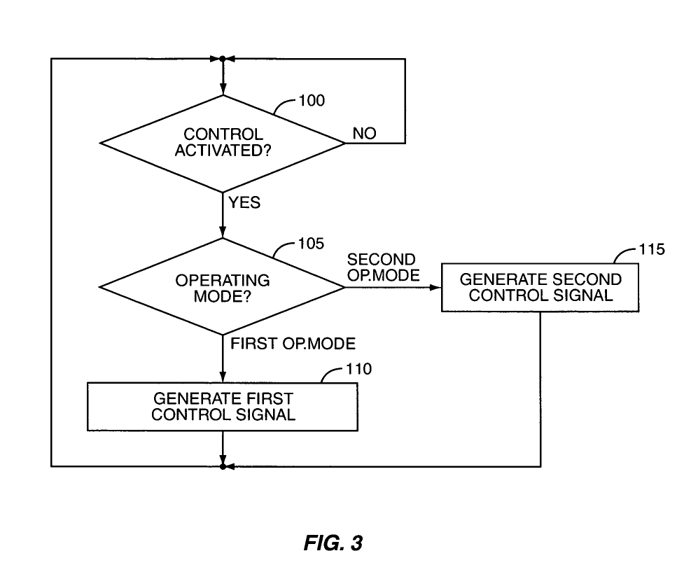

FIG. 3 illustrates a flow diagram of an exemplary process implemented by processor 26 when peripheral 10 is modal. When a multi-function control 14 is activated by a user (block 100), processor 26 generates a first control signal in a first operating mode (blocks 105, 110), and generates a second control signal in a second operating mode (blocks 105, 115). In so doing, processor 24 performs different functions related to the operation of mobile device 12 in different operating modes. For example, processor 26 generates a local volume control signal for controlling the volume of sounds projected by speaker 30 responsive to activation of multi-function controls 17, 18 in a call mode. In a camera mode, processor 26 generates a remote zoom control signal for transmission to mobile device 12 responsive to activation of the same multi-function controls 17, 18. Alternatively, processor 26 generates a remote call answer signal or a remote camera shutter control signal for transmission to mobile device 12 responsive to activation of the same multi-function control 16 in a call mode or camera mode, respectively.

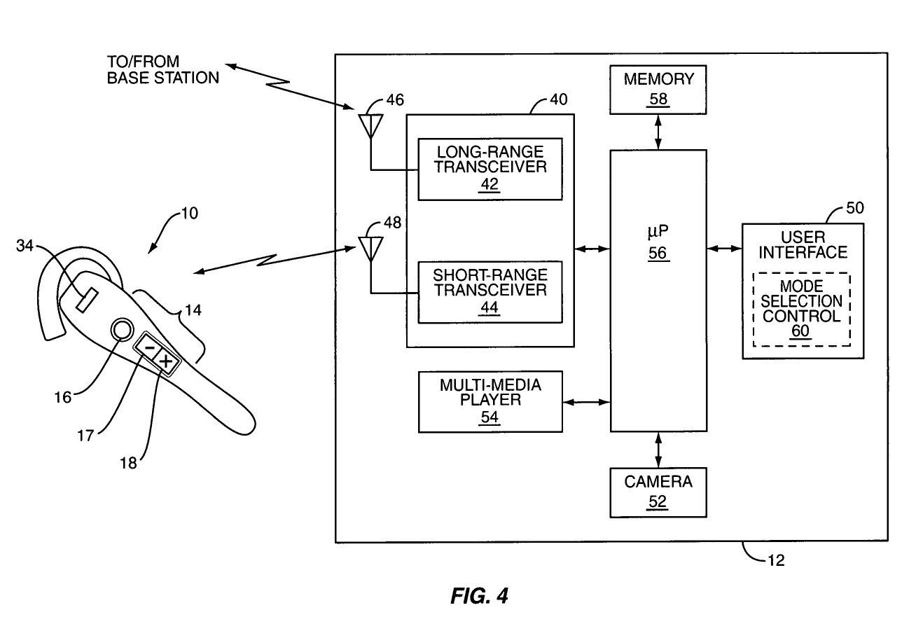

FIG. 4 illustrates a block diagram of an exemplary mobile device 12. Mobile device 12 includes a communication circuit 40 comprising a long-range wireless transceiver 42 and short-range wireless transceiver 44. Long-range wireless transceiver 42 transmits signals to and receives signals from one or more base stations via antenna 46 according to any known standard, including but not limited to, Global System for Mobile Communications (GSM), Universal Mobile Telecommunications System (UMTS), Code Division Multiple Access (CDMA), etc. Short-range wireless transceiver 44 communicates with nearby peripheral device(s) 10 according to any known short-range communication standard, such as Bluetooth®, infra-red, RF according to IEEE 802.11a, IEEE 802.11b, IEEE 802.11g, etc., via antenna 48.

Mobile device 12 also includes a user interface 50, optional camera 52, optional multi-media player 54, processor 56, and memory 58. While not explicitly shown, user interface 50 includes at least one of a speaker, microphone, one or more controls, display, etc., that enable a user to interact with mobile device 12. Further, user interface 50 optionally includes a mode selection control 60, such as a toggle switch, that selects a current operating mode. The camera 52 comprises any camera assembly known in the art, and may include any known camera elements, such as a lens assembly (not shown), an image sensor (not shown), and an image processor (not shown). Camera 52 performs multiple camera functions, such as shutter, zoom in, zoom out, focus, record, and flash functions responsive to user input. Multi-media player 54 comprises any known digital audio player, digital video player, or any combination thereof. While not explicitly shown, multi-media player 54 may include such elements as an audio processor, video processor, dedicated multi-media memory, etc. Multi-media player 54 performs multiple multi-media functions associated with a multi-media file, such as play, stop, pause, rewind, skip, etc., responsive to user input. Processor 56 performs various processing tasks, including control of the overall operation of mobile device 12, according to programs stored in memory 58 and responsive to user input. When mobile device 12 is modal, processor 56 interprets the same control signal received from peripheral 10 differently in different operating modes.

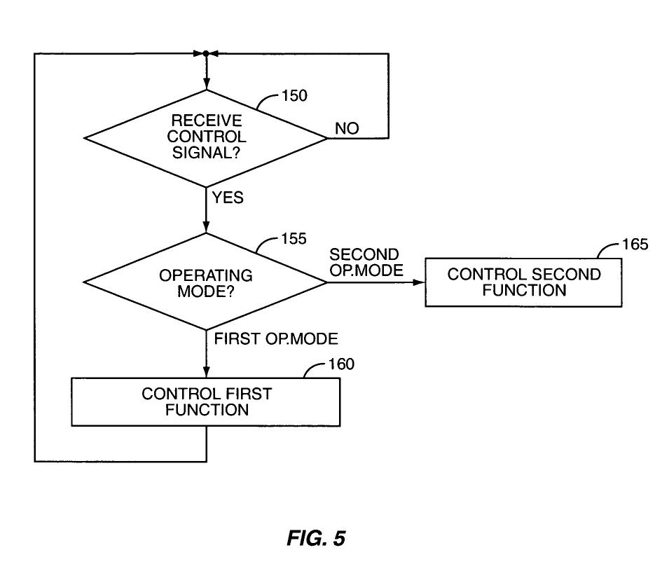

FIG. 5 illustrates a flow diagram of an exemplary process implemented by processor 56 when mobile device 12 is modal. When mobile device 12 receives a control signal from peripheral 10 that is associated with activation of a multi-function control 14 (block 150), processor 56 controls a first function in a first operating mode (blocks 155, 160), and controls a second function in a second operating mode (blocks 155,165). In so doing, processor 56 associates the same control signal received from peripheral 10 with different functions in different operating modes. For example, assume wireless peripheral 10 transmits a control signal to mobile device 10 responsive to activation of multi-function control 16. In a call mode, processor 56 answers a call responsive to receiving this control signal. However, in a camera mode, processor 56 activates a shutter of camera 52 responsive to receiving this control signal.

In one embodiment, the user sets the operating mode at wireless peripheral 10 and/or at mobile device 12 by providing mode control input to wireless peripheral 10. The mode control input may comprise a voice command provided to microphone 32, user input at a dedicated mode selection control 36, or user input according to a pre-defined peripheral control activation sequence. For example, the user may select an operating mode by pressing and holding control 16 for 5 seconds. Alternatively, the user may select an operating mode by simultaneously pressing control 17 and control 18. Responsive to the mode selection input, wireless peripheral 10 selects the operating mode of the peripheral 10 and/or sends a mode control signal to mobile device 12.

The user alternatively sets the operating mode at wireless peripheral 10 and/or at mobile device 12 by providing mode control input to mobile device 12. The mode control input may comprise a voice command, user input at a dedicated mode selection control 60, etc. Responsive to the mode selection input, mobile device 12 selects the operating mode of the mobile device 12 and/or sends a mode control signal to peripheral 10.

As shown in FIGS. 1 and 2, wireless peripheral 10 may optionally include an indicator 34 that provides operational information to the user. In some embodiments, indicator 34 provides a visual indication of the current operating mode. Indicator 34 may comprise any known indicator, including one or more light emitting diodes, an icon or text indicator on a display, etc. Alternatively, when peripheral 10 includes a mode selection control 36, indicator 34 may be part of mode selection control 36. For example, indicator 34 may comprise a colored area on mode selection control 36 that is concealed when mode selection control 36 is in one position and visible when mode selection control 36 is in a different position.

The above describes the present invention in terms of a wireless peripheral 10 that re-uses a multi-function control 14 to control different call and camera functions in different operating modes. However, multi-function control 14 may also control other functions related to the operation of mobile device 12. For example, multi-function control 14 may control a camera function in a camera mode and a multi-media function in a multi-media mode. Further, a multi-function control 14 may control a plurality of different functions in a plurality of different operating modes. For example, a multi-function control 14 may control a call function in a call mode, a camera function in a camera mode, a multi-media function in a multi-media mode, a voice mail function in a voice mail mode, etc.

The present invention applies to any known wireless peripherals compatible with any known mobile devices. An exemplary wireless peripheral may be any wireless headset or wireless device that communicates with a nearby mobile device and that includes one or more multi-function controls that operate as described herein. Exemplary mobile devices include wireless communication devices, e.g., cellular telephones, personal data assistants, laptop computers, palmtop computers, etc. Exemplary mobile devices also include digital audio players, e.g., MP3 players, and other multi-media players.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

We claim:

1. A wireless peripheral compatible with a mobile device, the wireless peripheral comprising:
a control accessible by a user of the wireless peripheral; and
a processor configured to perform a first function related to operation of the mobile device responsive to activation of the control in a first operating mode, and configured to perform a different second function related to operation of the mobile device responsive to activation of the control in a different second operating mode.

2. The wireless peripheral of claim 1 wherein the first function comprises a call function related to a call operation of the mobile device, and wherein the second function comprises an auxiliary function related to an auxiliary operation of the mobile device.

3. The wireless peripheral of claim 2 wherein the auxiliary function comprises a camera function, a multi-media function, or a voice mail function.

4. The wireless peripheral of claim 2 wherein the call function comprises a call answer function, and wherein the auxiliary function comprises a camera shutter function.

5. The wireless peripheral of claim 1 wherein the processor is further configured to select an operating mode responsive to a mode selection input.

6. The wireless peripheral of claim 5 wherein the mode selection input comprises one of a mode selection voice command, input from a mode selection control, input from one or more peripheral controls according to a predefined activation sequence, and a mode control signal received from the mobile device.

7. The wireless peripheral of claim 5 wherein when the processor selects the first operating mode, the processor performs the first function by generating a first control signal for transmission to the mobile device responsive to activation of the control, and wherein when the processor selects the second operating mode, the processor performs the different second function by generating a different second control signal for transmission to the mobile device responsive to activation of the same control.

8. The wireless peripheral of claim 5 wherein when the processor selects the first operating mode, the processor performs the first function by generating a local peripheral control signal that controls a wireless peripheral function independent of the mobile device responsive to activation of the control, and wherein when the processor selects the second operating mode, the processor performs the different second function by generating a remote control signal for transmission to the mobile device responsive to activation of the control.

9. The wireless peripheral of claim 1 further comprising a visual indicator configured to indicate a current operating mode.

10. The wireless peripheral of claim 1 wherein the wireless peripheral comprises a wireless headset.

11. A method of controlling a mobile device using a wireless peripheral, the method comprising:
receiving input from a multi-function control on the wireless peripheral; and
performing a first function related to the mobile device responsive to the received input in a first operating mode and performing a different second function related to the mobile device responsive to the received input in a second operating mode.

12. The method of claim 11 wherein performing the first function comprises performing a call function, and wherein performing the second function comprises performing an auxiliary function.

13. The method of claim 11 wherein the auxiliary function comprises a camera function, a multi-media function, or a voice mail function.

14. The method of claim 11 wherein call function comprises a call answer function, and wherein the auxiliary function comprises a camera shutter function.

15. The method of claim 11 further comprising selecting an operating mode responsive to a mode selection input.

16. The method of claim 15 wherein the mode selection input comprises one of a mode selection voice command, input from a mode selection control, input from one or more peripheral controls according to a predefined mode selection sequence, and a mode selection signal received from the mobile device.

17. The method of claim 15 wherein when the first operating mode is selected, performing the first function by transmitting a first control signal to the mobile device responsive to the multi-function control input, and wherein when the second operating mode is selected, performing the second function by transmitting a different second control signal to the mobile device responsive to the same multi-function control input.

18. The method of claim 15 wherein when the first operating mode is selected, performing the first function by directly controlling a wireless peripheral function independent of the mobile device responsive to the multi-function control input, and wherein when the second operating mode is selected, performing the second function by transmitting a remote control signal to the mobile device responsive to the multi-function control input.

19. The method of claim 11 further comprising providing a visual indication of a current operating mode on the wireless peripheral.

20. The method of claim 11 wherein the wireless peripheral comprises a wireless headset.

21. A mobile device comprising:
an interface configured to receive a control signal from a wireless peripheral; and
a processor configured to control different functions related to operation of the mobile device responsive to the received control signal in different operating modes.

22. The mobile device of claim 21 wherein the processor is configured to control a first function related to a first operation of the mobile device responsive to the received control signal in a first operating mode, and wherein the processor is configured to control a different second function related to a second operation of the mobile device responsive to the same received control signal in a second operating mode.

23. The mobile device of claim 22 wherein the second function comprises a camera function, a multi-media function, or a voice mail function.

24. The mobile device of claim 22 wherein the first function comprises a call function.

25. The mobile device of claim 22 wherein the first function comprises a call function and wherein the second function comprises a camera function.

26. The mobile device of claim 21 wherein the processor controls the different functions in different operating modes by associating different functions with the received control signal in different operating modes.

27. The mobile device of claim 26 wherein the processor controls the different functions by associating a call function with the received control signal in a call mode and associating a camera function with the received control signal in a camera mode.

28. The mobile device of claim 21 wherein the processor is further configured to set a current operating mode responsive to a mode selection input.

29. The mobile device of claim 21 wherein the mode selection input comprises one of a mode selection signal received from the wireless peripheral and input from a mobile device control.

30. The mobile device of claim 21 wherein the mobile device comprises a wireless communication device.

31. A method of controlling a mobile device comprising:
receiving a control signal from a wireless peripheral; and
controlling different functions related to operation of the mobile device responsive to the received control signal in different operating modes.

32. The method of claim 31 wherein controlling different functions comprises controlling a first function related to a first operation of the mobile device responsive to the received control signal in a first operating mode, and controlling a second function related to a second operation of the mobile device responsive to the received control signal in a second operating mode.

33. The method of claim 32 wherein the second function comprises a camera function, a multi-media function, or a voice mail function.

34. The method of claim 32 wherein the first function comprises a call function.

35. The method of claim 32 wherein the first function comprises a call function and wherein the second function comprises a camera function.

36. The method of claim 31 wherein controlling the different mobile device functions comprises associating different functions with the received control signal in different operating modes.

37. The method of claim 36 wherein associating different functions comprises associating a call function with the received control signal in a call mode and associating a camera function with the received control signal in a camera mode.

38. The method of claim 31 further comprising setting a current operating mode responsive to a mode selection input.

39. The method of claim 31 wherein the mode selection input comprises one of a mode selection signal received from the wireless peripheral and input from a mobile device control.

40. The method of claim 31 wherein the mobile device comprises a wireless communication device.
